(19) United States
(12) Patent Application Publication
(10) Pub. No.: US 2010/0229087 A1
(43) Pub. Date: Sep. 9, 2010

(54) COMPUTER READABLE MEDIUM, INFORMATION PROCESSING DEVICE AND IMAGE PROCESSING METHOD

(75) Inventor: Hiroyuki UEDA, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/549,025

(22) Filed: Aug. 27, 2009

(30) Foreign Application Priority Data
Mar. 6, 2009 (JP) 2009-053927

(51) Int. Cl. G06F 3/00

(52) U.S. Cl. 715/700

(57) ABSTRACT

An information processing device includes; a processing content information creating unit that creates processing content information indicative of content of processing corresponding to operation accepted for operation target information to be operated by a user; a processing content information storing unit that stores the processing content information; and an outputting unit that outputs the operation target information added with additional information corresponding to the processing content information stored by the processing content information storing unit.

### CROSS-REFERENCE TO RELATED APPLICATIONS

This application is based on and claims priority under 35 USC 119 from Japanese Patent Application No. 2009-053927 filed on Mar. 6, 2009.

### BACKGROUND

1. Technical Field

The invention relates to a computer readable medium, an information processing device and an information processing method.

### SUMMARY

According to an aspect of the invention, a computer readable medium storing a program causing a computer to execute a process, the process includes: creating processing content information indicative of content of processing corresponding to operation accepted for operation target information to be operated by a user; storing the processing content information in a memory; and outputting the operation target information added with additional information corresponding to the processing content information stored in the memory.

### BRIEF DESCRIPTION OF THE DRAWINGS

Exemplary embodiments of the invention will be described in detail based on the following figures, wherein:

FIG. 1 is a view showing an exemplary hardware configuration of the information processing device according to an exemplary embodiment of this invention;

FIG. 2 is a function block diagram showing an exemplary function realized by the information processing device according to the exemplary embodiment of this invention;

FIG. 3 is a view showing an exemplary operation screen;

FIG. 4 is a view showing an exemplary data structure of document corresponding information;

FIG. 5 is a view showing an exemplary data structure of processing content information;

FIG. 6 is a flowchart showing an exemplary flow of processing executed in the information processing device according to the exemplary embodiment;

FIG. 7 is a view showing an exemplary data structure of additional information;

FIG. 8 is a view showing an exemplary data structure of processing character string corresponding information;

FIG. 9 is a view showing an exemplary operation screen;

FIG. 10 is a view showing an exemplary operation screen; and

FIG. 11 is a view showing an example of additional information reflecting dialog.

### DETAILED DESCRIPTION

Hereinafter, a detailed explanation will be given of an exemplary embodiment of this invention.

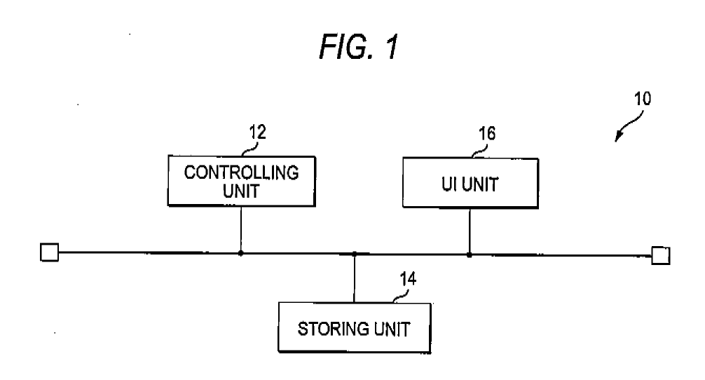

As illustrated in the hardware configuration view of FIG. 1, an information processing device 10 includes e.g. a controlling unit 12, a storing unit 14 and a user interface (UI) unit 16. These units are connected via e.g. bus.

The controlling unit 12 is a program control device such as a CPU that operates according to a program installed in the information processing device 10. The storing unit 14 is a memory such as ROM or RAM, or a hard disk. The storing unit 14 stores the program to be executed by the controlling unit 12 and others. The storing unit 14 also operates as a working memory of the controlling unit 12. The UI unit 16 is a display, a mouse or button that outputs the contents of operation executed by a user and sound inputted by the user. The UI unit 16 display-outputs or sound-outputs according to an instruction inputted from the controlling unit 12.

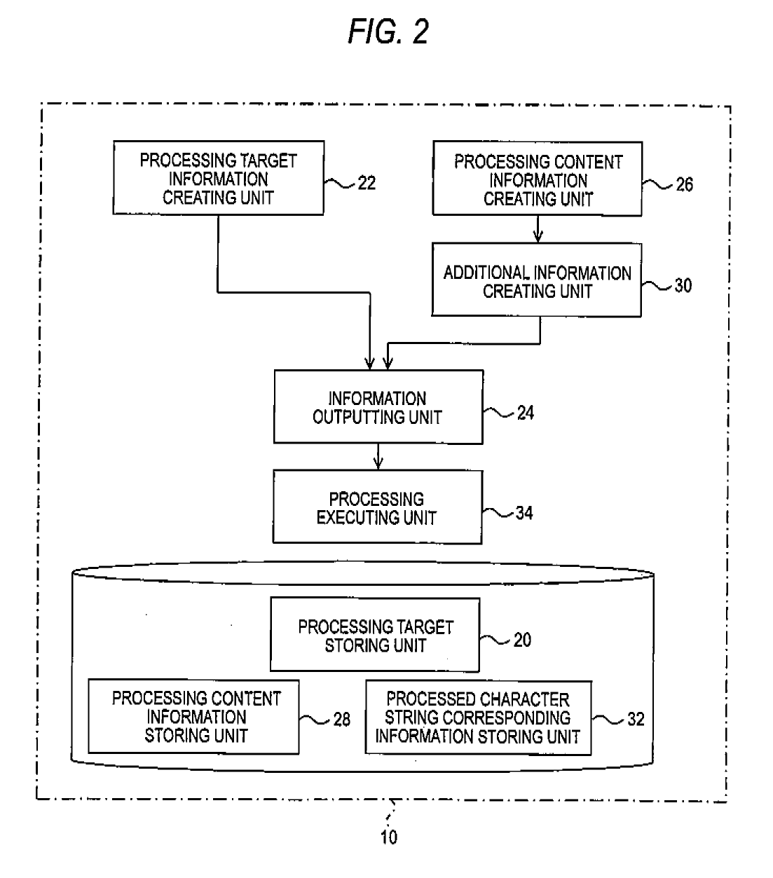

FIG. 2 is a function block diagram showing an exemplary function realized by the information processing device 10 according to an exemplary embodiment of this invention. As illustrated in FIG. 2, in this exemplary embodiment, the information processing device 10 functions to include e.g. a processing target information storing unit 20, an operation target information creating unit 22, an information outputting unit 24, a processing content information creating unit 26, a processing content information storing unit 28, an additional information creating unit 30, a processed character string corresponding information storing unit 32 and a processing executing unit 34. The processing target information storing unit 20, processing content information storing unit 28 and processed character string corresponding information storing unit 32 are mainly realized by the storing unit 14. The other units are mainly realized by the control unit 12.

These units are realized in such a manner that the program installed in the information processing device 10 that is a computer is executed by the controlling unit 12 of the information processing device 10. This program is supplied to the information processing device 10 through a computer readable information transmitting medium such as CD-ROM or DVD-ROM, or a communication network such as the Internet.

The processing target information storing unit 20 stores the processing target information to be processed. In this exemplary embodiment, the processing target information storing unit 20 stores the document information (hereinafter referred to as original document information) indicative of a document that is a target for edition processing.

The operation target information creating unit 22 creates, based on the processing target information, the operation target information corresponding to the processing target information.

The information outputting unit 24 outputs the output target information to the UI unit 16 such as a display.

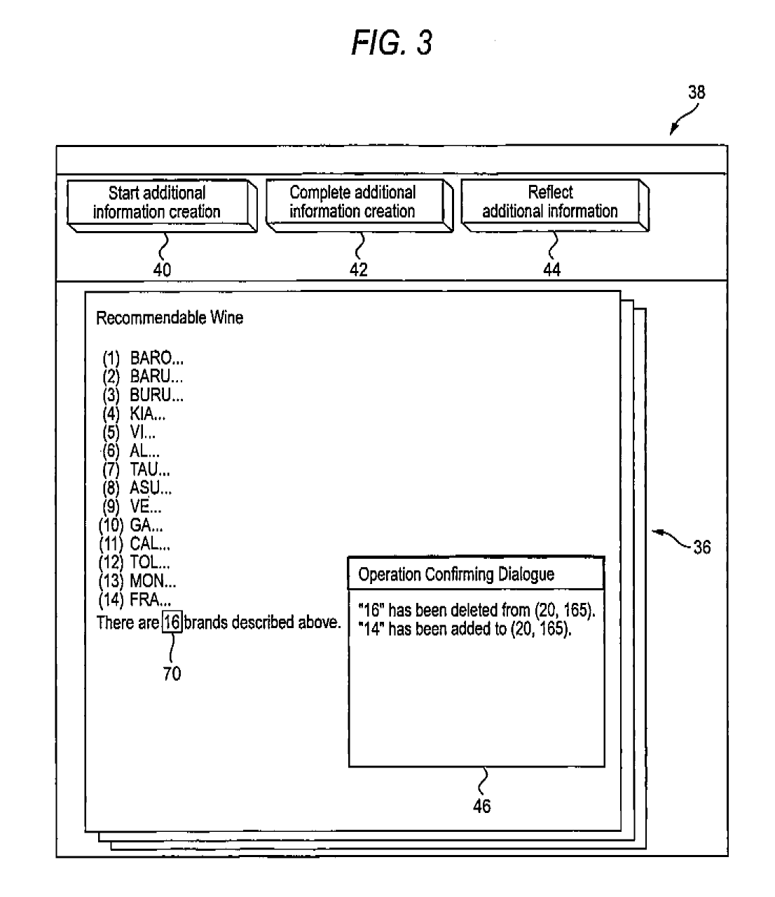

In this exemplary embodiment, the operation target information creating unit 22 executes, for example, file form conversion processing or format conversion processing for the original document information that is an example of the processing target information, thereby creating review document information 36 that is an example of the operation target information, corresponding to the original document information (see FIG. 3). Further, in this exemplary embodiment, the information outputting unit 24 display-outputs, for example, an operation screen 38 including the review document information 36 onto the UI unit 16 such as the display (see FIG. 3). FIG. 3 is a view showing an example of the operation screen 38 on which a character string is display-outputted by the processing exemplified later. As illustrated in FIG. 3, the operation screen 38 includes the review document information 36, an additional information creation starting button 40, an additional information creation completing button 42, an additional information reflecting button 44 and an operation confirming dialogue 46. The details of the operation screen 38 will be described later.

It should be noted that the review document information 36 may be document information for which the authorization of updating the document contents themselves (e.g. writing authorization) is not given to a user of the information processing device 10. The review document information 36 may refer to the same document as the original document information.

It should be noted that the operation target information creating unit 22 may create the review document information 36 as the document information different from the original document information. Further, the operation target information creating unit 22 may add the review document information 36 to the original document information so that the review document information 36 is contained as a part of the original document information.

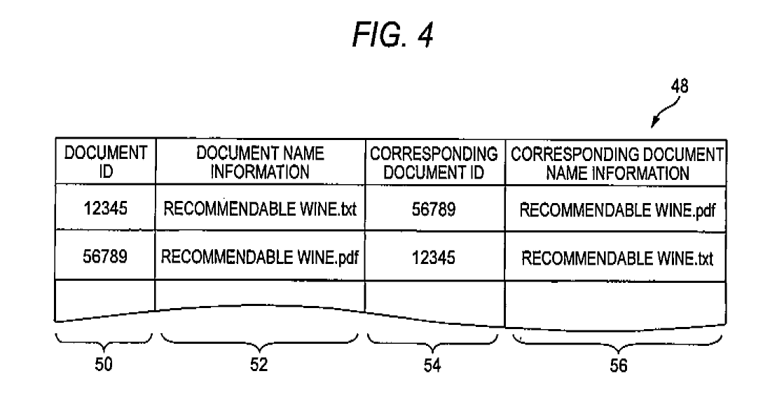

Further, in this exemplary embodiment, the operation target information creating unit 22 creates the document corresponding information 48 as illustrated in FIG. 4. FIG. 4 is a view showing an exemplary data structure of the document corresponding information 48. The document corresponding information 48 includes a document ID 50 being an identifier of the document information, document name information 52 indicative of the name of the document information, a corresponding document ID 54 being an identifier of the document information corresponding to the document information represented by the document ID 50, corresponding document information 56 indicative of the name of the document information represented by the corresponding document ID 54, etc. In this exemplary embodiment, for example, if the document ID 50 and document name information 52 correspond to the original document information, the corresponding document ID 54 and corresponding document name information 56 correspond to the review document information 36. Further, if the document ID 50 and document name information 52 correspond to the review document information 36, the corresponding document ID 54 and corresponding document name 56 correspond to the original document information.

In this exemplary embodiment, when the user presses the additional information creation starting button 40 included in the operation screen 38, the information outputting unit 24 accepts a signal indicative of the fact that the additional information creation starting button 40 has been pressed. The information outputting unit 24, in this exemplary embodiment, for example, outputs the operation confirming dialogue 46 into the operation screen 38 display-outputted on the UI unit 16 such as the display. It should be noted that the information outputting unit 24 may not display-output the operation confirming dialogue 46.

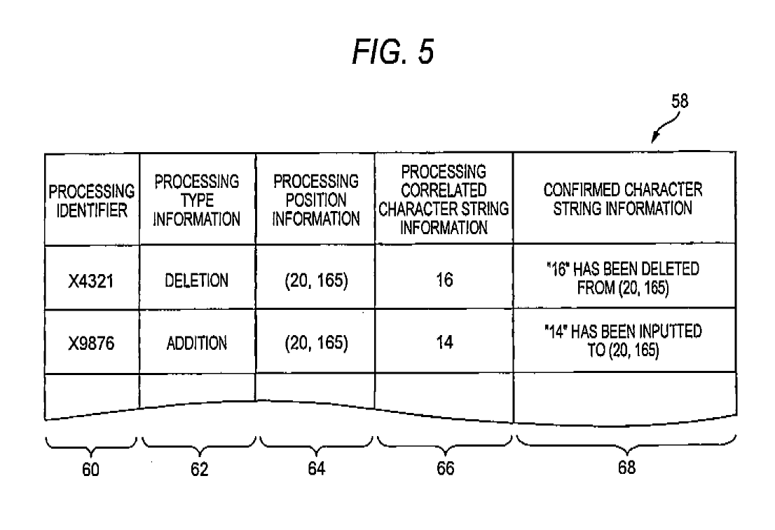

Further, if the user executes, by means of the UI unit 16 such as the mouse or keyboard, the operation of deleting the character string included in the review document information 36 or the operating of adding the character string to the review document information 36, the processing content information creating unit 26 accepts a signal corresponding to the operation executed by the user (operation signal). Further, the operation content information creating unit 26, on the basis of the operation (in this exemplary embodiment, e.g. the operation signal), creates processing content information 58 indicative of the contents of the processing to be executed for the original document information corresponding to the review document information 36 (see FIG. 5). In this way, the processing content information creating unit 26, according to the operation accepted from the user, creates the processing content information 58 indicative of the contents of the processing for the processing target information. In this exemplary embodiment, by the operation executed by the user, the review document information 36 itself will not be updated. Namely, in this exemplary embodiment, it can be said that the above operation executed by the user is a pseudo-operation. It should be noted that the processing content information creating unit 26 may create the processing content information 58 indicative of the contents of the processing for the operation target information.

FIG. 5 is a view showing an exemplary data structure of the processing content information 58. As illustrated in FIG. 5, the processing content information 58 concretely includes, for example, a processing identifier 60 being an identifier of the processing, processing type information 62 indicative of the type of the processing (e.g. “deletion” or “addition”), processing position information 64 indicative of the position (e.g. coordinates) within the processing target information where the processing is to be executed, processing correlated character string information 66 indicative of the character string correlated with the processing, confirmed character string information 68 to be display-outputted within the operation confirming dialogue 46, etc. The processing content information 58 may not contain the confirmed character string information 68.

In this exemplary embodiment, the position within the review document information 36 where the operation (pseudo-operation) has been executed by the user corresponds to the position within the original document information where the processing is to be executed (i.e. the position represented by the processing position information 64). Further, in this exemplary embodiment, for example, the character string represented by the processing correlated character string information 66 corresponds to the character string inputted by the user.

The processing content information creating unit 26 outputs the processing content information 58 to the processing content information storing unit 28. The processing content information storing unit 28 stores the processing content information 58. The processing content information storing unit 28 may store a plurality of sets of processing content information 58.

In this exemplary embodiment, if the processing content information creating unit 26 creates the processing content information 58, the information outputting unit 24 display-outputs the character string corresponding to the confirmed character string information 68 within the operation confirming dialogue 46. FIG. 3 shows an example of the operation screen 38 after the character string has been display-outputted within the operation confirming dialogue 46. Further, in this exemplary embodiment, the information outputting unit 24, for example, display-outputs a marker image 70 at the position corresponding to the position represented by the processing position information 64 (i.e. in this exemplary embodiment, the position where the operation has been executed by the user).

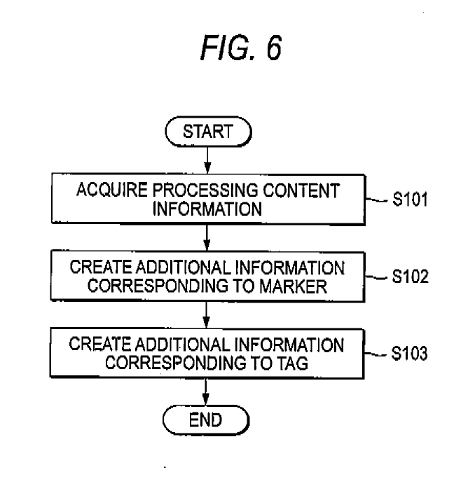

If the user presses the additional information creation completing button 42, the additional information creating unit 30 executes the additional information creating processing. Now, an example of the additional information creating processing will be explained referring to the flowchart illustrated in FIG. 6.

First, the additional information creating unit 30 acquires the processing content information 58 stored in the processing content information storing unit 28 (S101).

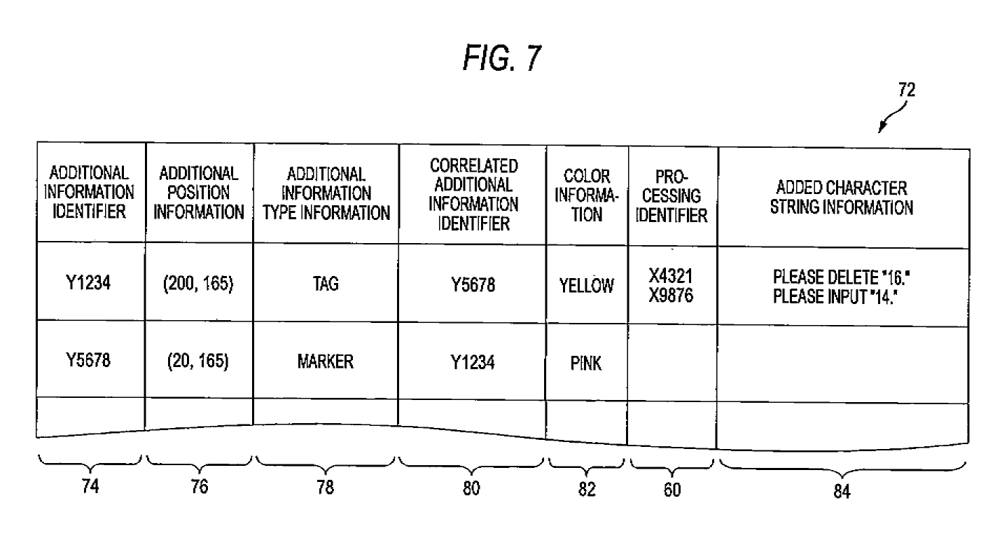

Next, the additional information creating unit 30 creates the additional information 72 (see FIG. 7) corresponding to a marker on the basis of the processing content information 58 (S102). FIG. 7 is a view showing an exemplary data structure of the additional information 72. As illustrated in FIG. 7, the additional information 72 includes for example, an additional information identifier 74 being an identifier of the additional information 72, additional information position information 76 indicative of the position (e.g. coordinates) where the additional information is to be display-outputted, additional information type information 78 indicative of the type of the additional information 72 (e.g. tag or marker), a correlated additional information identifier 80 indicative of the identifier of the correlated additional information 72, color information 82 indicative of the color of the additional information 72, the processing identifier 60 of the processing content information 58 corresponding to the additional information 72, additional character string information 84 indicative of the character string (text information) that is to be display-outputted in the UI unit 16, etc.

In this exemplary embodiment, in the processing exemplified in S102, the additional information creating unit 30 concretely creates the additional information 72 that contains, for example, the additional information position information 76 that is determined on the basis of the processing position information 64 contained in the processing content information 58 (corresponding to the position represented by the processing position information 64), additional information type information 78 with the value being the “marker”, etc.

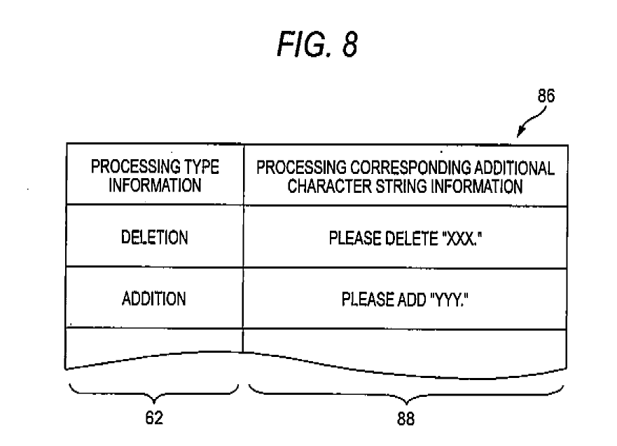

The additional information creating unit 30 creates the additional information 72 corresponding to the tag of the additional information type information 78 with the value being the “tag” on the basis of the processing content information 58 acquired in the processing exemplified in S101 and processed character string corresponding information 86 (see FIG. 8) previously stored in the processed character string corresponding information storing unit 32 (S103). FIG. 8 is a view showing an exemplary data structure of the processed character string 86. As illustrated in FIG. 8, the processed character string corresponding information 86 includes the processing type information 62 and the processing corresponding additional character string information 88 indicative of the character string corresponding to the processing type information 62. In the processing exemplified in S103, the additional information creating unit 30, on the basis of the processed character string corresponding information 86, specifies the processing corresponding additional character string information 88 corresponding to the processing type information 62 contained in the processing content information 58. The additional information creating unit 30 creates the additional character string information 84 on the basis of the processing corresponding additional character string information 88 and the character string represented by the processing correlated character string information 66 contained in the processing content information 58. Further, the additional information creating unit 30 creates the additional information 72 containing the additional character string information 84 and others.

The additional information creating unit 30 may create the additional information 72 corresponding to the tag, containing the additional position information 76 corresponding to a combination of the X coordinate corresponding to the position at the right end within the review document information 36 and the Y coordinate common to the processing position information 64 contained in the processing content information 58. Further, the additional information creating unit 30 may create a single set of additional information 72 on the basis of a plurality of sets of processing content information 58. Further, the additional information creating unit 30 may create a plurality of sets of additional information 72 corresponding to one another (e.g. correlated by the correlative additional information 72).

In the processing exemplified in S101 to S103 described above, the additional information 72 is created.

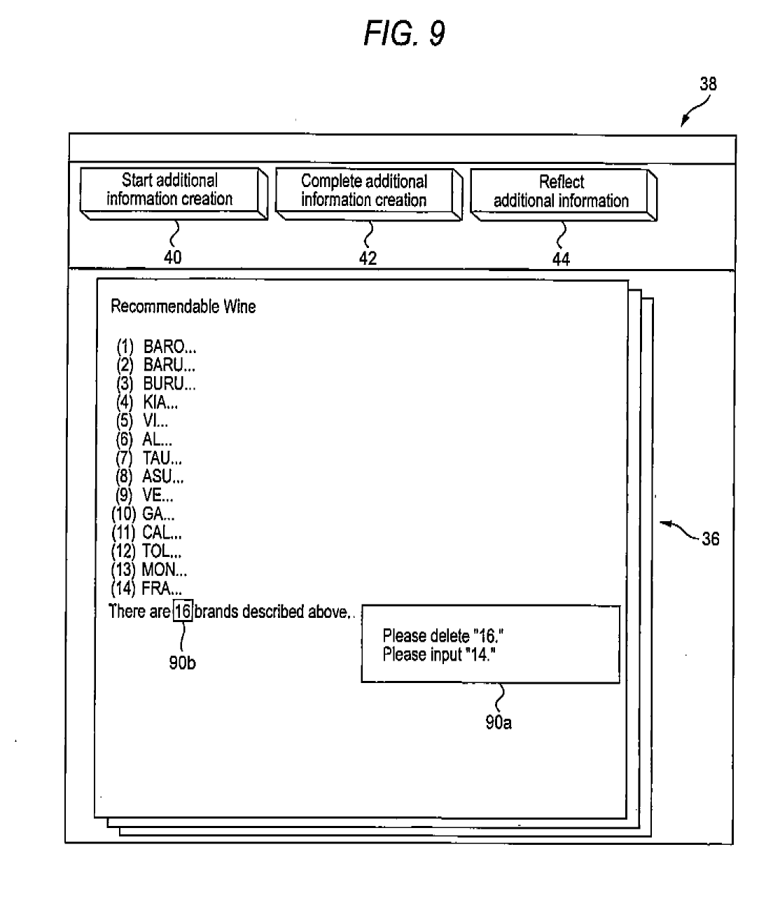

The information outputting unit 24 adds, to the output target information (in this exemplary embodiment, e.g. the review document information 36), the additional information 72 corresponding to the processing content information 58 stored in the processing content information storing unit 28 (in this exemplary embodiment, e.g. the additional information 72 created by the additional information creating unit 30). In this exemplary embodiment, the information outputting unit 24 display-outputs, on the UI unit 16 such as the display, the operation screen 38 with an additional image 90 added to the review document information 36, illustrated in FIG. 9. As illustrated in FIG. 9, the information outputting unit 24 may process the additional information 72 so that it is display-outputted as e.g. the image (additional image 90) corresponding to the additional information 72. In this exemplary embodiment, the information outputting unit 24 outputs the additional image 90 at the position determined on the basis of the processing position information 64 (e.g. position corresponding to the additional position information 76 contained in the additional information 72).

The operation screen 38 illustrated in FIG. 9 includes two additional images 90 (tag-added image 90a indicative of the tag and a marker-added image 90b indicative of the marker). The tag-added image 90a corresponds to the additional information 72 with the value of the additional information type information 78 being the “tag”, and the marker-added image 90b corresponds to the additional information 72 with the value of the additional information type information 78 being the “marker”.

When the user executes the operation of selecting the tag-added image 90a by means of the UI unit 16 such as the mouse, the information outputting unit 24 may accept the signal indicative of the pertinent operation thereby to display-output the marker-added image 90b corresponding to the tag-added image 90a onto the UI unit 16 such as the display. Further, in response to a request from the user, the information outputting unit 24 may output the review document information 36 added with the additional information 72 into the storing unit 14 of the information processing device 10 or a storage device connected to the information processing device 10 through the network.

When the user presses the additional information reflecting button 44 by means of the UI unit 16 such as the mouse after he selects the tag-added image 90a by means of the UI unit 16 such as the mouse, the processing executing unit 34 accepts the signal indicative of the fact the additional information reflecting button 44 has been pressed and executes the operation corresponding to the tag-added image 90a selected by the user at this time for the processing target information (in this exemplary embodiment, e.g. the original document information). The processing executing unit 34 concretely executes the processing of specifying the character string to be operated of the respective characters included in the original document information on the basis of the processing position information 64 and updating the character string specified. The processing executing unit 34 may create the original document information after the processing from the review document information 36 on the basis of the processing content information 58 thereby to update the entire original document information. Further, another user different from the user having pressed the above additional information creation completing button 42 may open the review document information 36 and press the additional information reflecting button 44. The processing executing unit 34 may execute the processing for the operation target information.

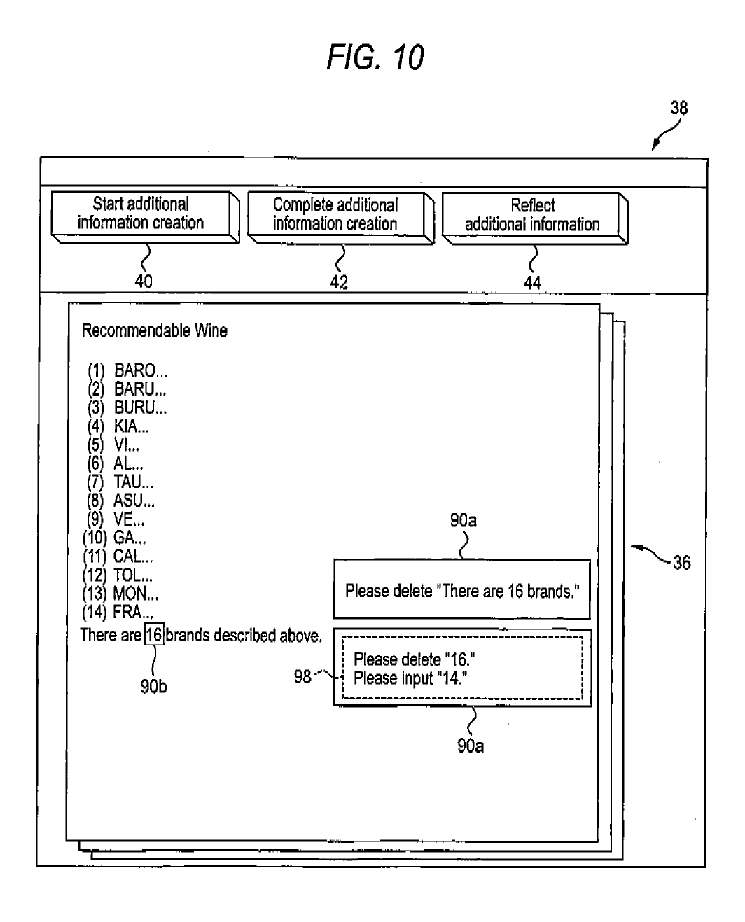

FIG. 10 shows an exemplary operation screen 38 with a plurality of tag-added images 90a. These plurality of tag-added images 90a correspond to processing content information 58 that is a creating basis of the additional information 72. In the example of FIG. 10, plural tag-added images 90a correspond to one another. Concretely, for example, for the marker-added image 90b corresponding to each tag-added image 90a, the additional position information 76 corresponding to the marker-added image 90b is common.

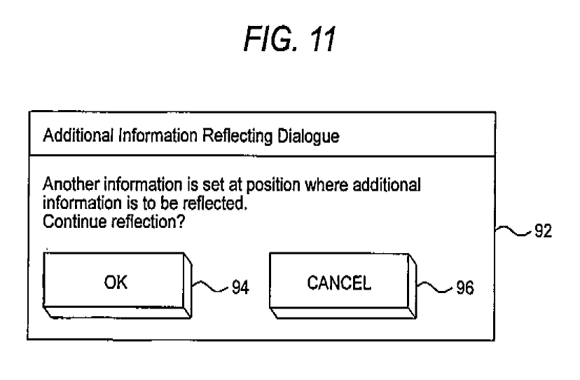

When the user presses the additional information reflecting button 44 by means of the UI unit 16 such as the mouse after he selects any selected image of these plurality of tag-added images 90a by means of the UI unit 16 such as the mouse, the information outputting unit 24 display-outputs, on the UI unit 16 such as the display, the information indicative of the fact that the plurality of sets of additional information 72 corresponding to one another are added to the operation target information (for example, an additional information reflecting dialogue 92 illustrated in FIG. 11). The additional information reflecting dialogue 92 includes an OK button 94 and a cancel button 96. As illustrated in FIG. 10, the information outputting unit 24 may display-output the operation screen 38 on which a mark 98 is added to the selected image.

When the user presses the OK button 94, the processing executing unit 34 accepts the signal indicative of the fact that the OK button 94 has been pressed and executes the operation corresponding to the selected image for the processing target information (in this exemplary embodiment, for example, the original document information). In this way, the processing executing unit 34 may accept selected information indicative of at least one set of additional information 72 selected from the plurality of sets of additional information 72 and execute the operation corresponding to the selected signal for the processing target information. It should be noted that the processing executing unit 34 may execute the operation corresponding to the selected information for the operation target information.

It should be noted that this invention should not be limited to the exemplary embodiment described above.

For example, the information outputting unit 24 may display-output, on the UI unit 16 such as the display, the operation screen 38 including the original document information (for example, in the state where the authorization of updating the original document information itself (e.g. writing authorization) is not given to the user of the information processing device 10).

Further, for example, in a display application of the original document information, accepting the request from the user, the information outputting unit 24 may display-output, on the UI unit 16 such as the display, the operation screen 38 including the review document information 36 corresponding to the original document information.

Further, the information outputting unit 24 may display-output the additional information 72 (e.g. additional image 90) in a displaying manner such as a balloon or a dialogue box other than the tag.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable medium storing a program causing a computer to execute a process, the process comprising:
creating processing content information indicative of content of processing corresponding to operation accepted for operation target information to be operated by a user;
storing the processing content information in a memory; and
outputting the operation target information added with additional information corresponding to the processing content information stored in the memory.

2. The computer readable medium according to claim 1, the process further comprising:
executing processing for the operation target information in a case where after the outputting the operation target information added with the additional information, a request of executing processing represented by the processing content information is accepted from a user.

3. The computer readable medium according to claim 2, wherein
the memory stores a plurality of sets of the processing content information,
the outputting includes outputting the operation target information added with a plurality of sets of the additional information respectively corresponding to the plurality of the processing content information stored in the memory, and
the executing includes executing for the operation target information the processing represented by the processing content information corresponding to the additional information selected by the user from the plurality of sets of the additional information.

4. The computer readable medium according to claim 1, the process further comprising:
executing processing for the processing target information corresponding to the operation target information in a case where after outputting the operation target information added with the additional information, a request of executing processing represented by the processing content information is accepted from a user.

5. The computer readable medium according to claim 4, wherein
the memory stores a plurality of sets of the processing content information,
the outputting includes outputting the operation target information added with a plurality of sets of the additional information respectively corresponding to the plurality of the processing content information stored in the memory, and
the executing includes executing for the processing target information the processing represented by the processing content information corresponding to the additional information selected by the user from the plurality of sets of the additional information.

6. The computer readable medium according to claim 1, wherein
the creating includes creating the processing content information containing processing position information indicative of a position within the operation target information for which the processing is to be executed, and
the outputting includes outputting the additional information added to the position determined based on the processing position information.

7. The computer readable medium according to claim 1, wherein
the outputting includes outputting the operation target information added with first additional information indicative of content of processing specified based on the processing content information and second additional information indicative of a position where the processing specified by the processing content information is to be executed.

8. The computer readable medium according to claim 1, the process further comprising:
creating the additional information based on the processing content information, wherein
the outputting includes outputting the operation target information added with the created additional information.

9. The computer readable medium according to claim 8, wherein
the creating the additional information includes creating the additional information containing text information indicative of the content of the processing represented by the processing content information.

10. The computer readable medium according to claim 1, wherein
when a plurality of sets of the additional information corresponding to one another are added to the operation target information, the outputting includes outputting information indicative of this fact,

11. The computer readable medium according to claim 4, the process further comprising:
creating the operation target information corresponding to the processing target information based on the processing target information.

12. An information processing device comprising:
a processing content information creating unit that creates processing content information indicative of content of processing corresponding to operation accepted for operation target information to be operated by a user;
a processing content information storing unit that stores the processing content information; and
an outputting unit that outputs the operation target information added with additional information corresponding to the processing content information stored by the processing content information storing unit.

13. An information processing method comprising:
creating processing content information indicative of content of processing corresponding to operation accepted for operation target information to be operated by a user;
storing the processing content information in a memory; and
outputting the operation target information added with additional information corresponding to the processing content information stored in the memory.
